(19) United States
(12) Patent Application Publication
(10) Pub. No.: US 2012/0197499 A1
(43) Pub. Date: Aug. 2, 2012

(54) UNDERGROUND MEASURING DEVICES

(75) Inventor: TAI CHEUNG POON, HONG KONG (HK)

(73) Assignee: UNDERGROUND DEVELOPMENT LIMITED, HONG KONG (HK)

(21) Appl. No.: 13/015,973

(22) Filed: Jan. 28, 2011

(51) Int. Cl. G06F 19/00; G06T 15/00; G01V 3/11

(52) U.S. Cl. 701/50; 324/329; 345/419

(57) ABSTRACT

A cable detection device is provided for measuring underground cable conditions. In one embodiment, a detection device is provided, including a handle for detecting underground cables; a digging component for digging, wherein the component is attached to a bottom of the handle; a panel attached on the bottom of the handle; a set of sensors attached to the panel, where the sensors are for detecting presence of cables by magnetic fields before digging occurs or during digging when the digging component undergoes operation, and where the sensors are tunneling magnetoresistance (TMR) sensors that are small in size, and where each sensor is placed evenly on the panel as an n by n array orientation, in order to maximize the sensitivity of the magnetic waves transmitted by the TMRs. The embodied device also includes a display unit attached on top of the handle, wherein the display unit allows an operator of the detecting device to display a three-dimensional image showing a cable being laid underground, when the cable is being found underground;

the distance between the underlying cable and ground level both graphically and numerically, based on strength of the magnetic fields reported by the set of sensors attached to the panel. The embodied device further includes a set of wheels attached on the bottom of the handle, allowing the operator to detect the underground cables with mobility. Furthermore, a location locating unit is attached to the panel, allowing the detecting device to identify its present position.

### FIELD OF THE INVENTION

This invention is generally related to measuring underground activities. Specifically, but not limited to, this invention relates to allowing operators to detect the underground cables with mobility. More specifically, this invention provides a three-dimensional image showing a cable being laid underground, when the cable is being found underground. Even more specifically, this invention measures the distance between the underlying cable and ground level both graphically and numerically, based on strength of the magnetic fields reported by the set of sensors attached to the panel.

### BACKGROUND OF THE INVENTION

It is imperative to make sure if diggers perform their work without affecting any cables lying underground. Currently, tools used to detect cables and tools used for digging are treated separately. The problem is that when diggers perform their work, they have to ask detectors to detect if any under cables are found underneath. This arrangement is inefficient. It is desirable for the diggers to know how much deeper they can dig when the digging takes place. Also, it is useful to keep track all the cables once detection has been performed, in view of the location where detection takes place.

Traditional means to determine if any underground cables are found include using single devices without connecting to remote servers. By using information technologies, requests to remote servers may allow construction workers to query whether an examination of the present position has ever been performed before and whether any underlying cables are found. Remote servers designed centrally can manage information of information for all locations under its management. If the present position has been performed before and a local item was reportedly found, a reply may be sent from the remote server. Typically, any information may be sent from the remote server and be displayed on the display unit of the local device. Such information may include data in the context of local information between the remote server and the local device, based on information detected by the local device.

Advantages of using means of information technology includes saving time, improving efficiency, and reducing costs for combining the features of both remote servers and local devices. With the tools described in this invention, it is not required to invite other people to perform detection. The workers can simply detect while digging, and the workers know how much deeper they can dig before an underlying cable is reached.

### SUMMARY OF THE INVENTION

Embodiments of the present invention include an underground cable detecting device. In one embodiment, an underground cable detecting device is provided, which comprises a handle for detecting underground cables; a panel attached on bottom of the handle; a set of sensors attached to the panel, where the sensors are for detecting presence of cables by magnetic fields; a display unit attached on top of the handle, wherein the display unit allows an operator of the detecting device to display a three-dimensional image showing a cable being laid underground, when the cable is being found underground. The detecting device may also display the distance between the underlying cable and ground level both graphically and numerically, based on strength of the magnetic fields reported by the set of sensors attached to the panel. The embodied device may include a set of wheels attached on the bottom of the handle, allowing the operator to detect the underground cables with mobility. In addition, a location locating unit attached to the panel may be included, allowing the detecting device to identify its present position. Moreover, a control unit may be attached to the panel, wherein the control unit comprises a processor and a memory storing a method that can be executed by the processor. The process may comprise sending a request to a remote server to query whether an examination of the present position has ever been performed before and whether any underlying cables are found, wherein the present position is determined by the location locating unit, and the remote server centrally manages information of underlying cable information for all locations under its management. if the present position has been performed before and an underlying cable was reportedly found by other underlying detecting devices, the device may receive a reply from the remote server, wherein the reply includes data from the remote server to be displayed on the display unit. The exemplary data may contain the distance between the underlying cable and ground level both graphically and numerically, based on the strength of the magnetic fields reported by the other underground detecting devices. The data may also include a photo relates to the underlying cable; a photo relating to the underlying cable and its surroundings; the type of cable, according to frequency of signals reported by the other underground cable detecting devices. If the present position has yet to be performed before, the set of sensors may be used to detect if any underlying cables are found. Meanwhile, when a cable is found, the distance may be detected by the device. Also, the device may display numerically and graphically the cable on the display unit; and send an alert to the remote server to report its findings, wherein the alert includes information regarding the present position, the photo relating to the surrounding, the type of cable by the frequency of signals detected by the underlying cable device, and the distance between the underlying cable and the ground, and wherein the remote server allows another user to send requests to the remote server to query whether examinations of the present position have ever been performed before and whether any underlying cables have been found.

In accordance to one aspect of the invention, a set of sensors may be attached to the panel in a number of configurations. In one configuration, the sensors attached to the panel may be used for detecting presence of cables by magnetic fields before digging occurs or during digging when the digging component undergoes operation, in order to facilitate the construction workers to detect if any cables may be found in different phases of the construction. Further, each sensor attached may be placed evenly on the panel as an n by n array orientation, in order to maximize the sensitivity of the magnetic waves transmitted by the TMRs.

In another aspect of the invention, the sensors used in this invention may record positions that have performed detection previously. In one embodiment, if the present position has yet to be performed before, the set of sensors may be used to detect if any underlying cables are found. When reportedly by the sensor that a underlying cable is found, the device may begin detecting the distance. The device may then display numerically and graphically the cable on the display unit, showing depth of the cable; thereafter sends an alert to the remote server to report its findings, wherein the alert includes information regarding the present position, the photo relating to the surrounding, the type of cable by the frequency of signals detected by the underlying cable device, and the distance between the underlying cable and the ground. The remote server may then allow another user to send requests to the remote server to query whether examinations of the present position have ever been performed before and whether any underlying cables have been found using the digging component for performing digging of the present position while using the set of sensors to closely monitor the shortening distance between the digging component and the underlying cable; warning about the shortening distance between the digging component and the underlying cable; and stopping the use of the digging component to further perform digging, when the distance between the digging component and the underlying cable reaches an unacceptable level. In accordance to one embodiment. The warning sent to the remote server may also contain other information. In one embodiment, the warning includes information about the digging activities and the shortening distance between the digging component and the underlying cable.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a system for measuring underground cable conditions, consistent with an embodiment of the invention.

### DETAILED DESCRIPTION

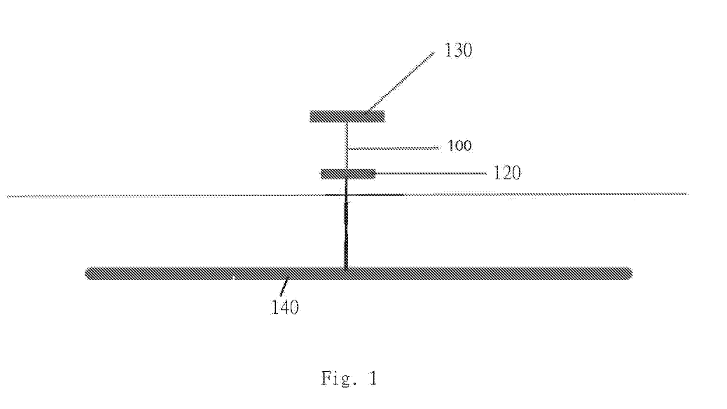

Embodiments of the present invention relates to a device for measuring underground cable conditions. Referring to FIG. 1, an exemplary device is illustrated. The device includes a digging device supporting detection of presence of underground cable during its operation. The device comprises a handle (100) for detecting underground cables; a digging component for digging, wherein the component is attached to a bottom of the handle. The device may also include a panel attached on the bottom of the handle; a set of sensors attached to the panel, where the sensors are for detecting presence of cables (140) by magnetic fields before digging occurs or during digging when the digging component undergoes operation.

In the exemplary device, a display unit may be attached. The point of attachment may be on top of the handle, wherein the display unit allows an operator of the detecting device to display a number of items on the screen. One item includes a three-dimensional image showing a cable (140) being laid underground, when the cable (140) is being found underground. A next item may be displayed, including the distance between the underlying cable (140) and ground level both graphically and numerically, based on strength of the magnetic fields reported by the set of sensors attached to the panel.

The exemplary device may include other components. One component includes a set of wheels attached on the bottom of the handle, allowing the operator to detect the underground cables (140) with mobility. Also, a location locating unit may be attached to the panel, allowing the detecting device to identify its present position. Further, a control unit may be attached to the panel, wherein the control unit comprises a processor and a memory storing a method that can be executed by the processor.

The process that can be executed by said processor may include a plurality of steps. In one instance, the processor may be requested to perform sending a request to a remote server to query whether an examination of the present position has ever been performed before and whether any underlying cables (140) are found, wherein the present position is determined by the location locating unit. The remote server centrally manages information of underlying cable information for all locations under its management. If the present position has been performed before and an underlying cable (140) was reportedly found by other underlying detecting devices. In which case, the device of this invention would receive a reply from the remote server, wherein the reply includes data from the remote server to be displayed on the display unit. The data may contain information directly related to the detection of cables. One such information includes the distance between the underlying cable (140) and ground level both graphically and numerically, based on the strength of the magnetic fields reported by the other underground detecting devices. In addition, a photo related to the underlying cable (140) may be included. Further, a photo related to the underlying cable (140) and its surroundings may also provided. More, the type of cable (140) may be included, according to frequency of signals reported by the other underground cable (140) detecting devices. If, however, the present position has yet to be performed before, the set of sensors may be used to detect if any underlying cables (140) are found. When reportedly by the sensor (120) that a underlying cable (140) is found, the device may detect the distance; display numerically and graphically the cable (140) on the display unit, showing depth of the cable; sending an alert to the remote server to report its findings, wherein the alert includes information regarding the present position, the photo relating to the surrounding, the type of cable (140) by the frequency of signals detected by the underlying cable device, and the distance between the underlying cable (140) and the ground, and wherein the remote server allows another user to send requests to the remote server to query whether examinations of the present position have ever been performed before and whether any underlying cables (140) have been found; using the digging component for performing digging of the present position while using the set of sensors to closely monitor the shortening distance between the digging component and the underlying cable; warning about the shortening distance between the digging component and the underlying cable; and stopping the use of the digging component to further perform digging, when the distance between the digging component and the underlying cable (140) reaches an unacceptable level.

In a different aspect of the invention, the inventive device includes an underground cable detecting device, which comprises a handle (100) for detecting underground cables; a panel attached on bottom of the handle; a set of sensors attached to the panel, where the sensors are for detecting presence of cables (140) by magnetic fields; a display unit attached on top of the handle, wherein the display unit allows an operator of the detecting device to display a three-dimensional image showing a cable (140) being laid underground, when the cable (140) is being found underground. The detecting device may also display the distance between the underlying cable (140) and ground level both graphically and numerically, based on strength of the magnetic fields reported by the set of sensors attached to the panel. The embodied device may include a set of wheels attached on the bottom of the handle, allowing the operator to detect the underground cables (140) with mobility. In addition, a location locating unit attached to the panel may be included, allowing the detecting device to identify its present position. Moreover, a control unit may be attached to the panel, wherein the control unit comprises a processor and a memory storing a method that can be executed by the processor. The process may comprise sending a request to a remote server to query whether an examination of the present position has ever been performed before and whether any underlying cables (140) are found, wherein the present position is determined by the location locating unit, and the remote server centrally manages information of underlying cable information for all locations under its management. if the present position has been performed before and an underlying cable (140) was reportedly found by other underlying detecting devices, the device may receive a reply from the remote server, wherein the reply includes data from the remote server to be displayed on the display unit. The exemplary data may contain the distance between the underlying cable (140) and ground level both graphically and numerically, based on the strength of the magnetic fields reported by the other underground detecting devices. The data may also include a photo relates to the underlying cable; a photo relating to the underlying cable (140) and its surroundings; the type of cable, according to frequency of signals reported by the other underground cable detecting devices. If the present position has yet to be performed before, the set of sensors may be used to detect if any underlying cables (140) are found. Meanwhile, when a cable (140) is found, the distance may be detected by the device. Also, the device may display numerically and graphically the cable (140) on the display unit; and send an alert to the remote server to report its findings, wherein the alert includes information regarding the present position, the photo relating to the surrounding, the type of cable (140) by the frequency of signals detected by the underlying cable device, and the distance between the underlying cable and the ground, and wherein the remote server allows another user to send requests to the remote server to query whether examinations of the present position have ever been performed before and whether any underlying cables (140) have been found.

In another implementation, the inventive device comprises a digging device supporting detection of presence of underground cable (140) during its operation. The device in this implementation may include a handle (100) for detecting underground cables; a digging component for digging, wherein the component is attached to a bottom of the handle (100); a panel attached on the bottom of the handle (100); a set of sensors attached to the panel, where the sensors are for detecting presence of cables (140) by magnetic fields before digging occurs or during digging when the digging component undergoes operation, and where the sensors are tunneling magnetoresistance (TMR) sensors that are small in size, and where each sensor (120) is placed evenly on the panel as an n by n array orientation, in order to maximize the sensitivity of the magnetic waves transmitted by the TMRs; a display unit attached on top of the handle (100), wherein the display unit allows an operator of the detecting device to display a three-dimensional image showing a cable (140) being laid underground, when the cable (140) is being found underground; the distance between the underlying cable (140) and ground level both graphically and numerically, based on strength of the magnetic fields reported by the set of sensors attached to the panel; a set of wheels attached on the bottom of the handle (100), allowing the operator to detect the underground cables (140) with mobility; a location locating unit attached to the panel, allowing the detecting device to identify its present position; a control unit attached to the panel, wherein the control unit comprises a processor and a memory storing a method that can be executed by the processor, wherein the process comprises sending a request to a remote server to query whether an examination of the present position has ever been performed before and whether any underlying cables (140) are found, wherein the present position is determined by the location locating unit, and the remote server centrally manages information of underlying cable information for all locations under its management. If the present position has been performed before and an underlying cable was reportedly found by other underlying detecting devices, receiving a reply from the remote server, wherein the reply includes data from the remote server to be displayed on the display unit, the data containing the distance between the underlying cable (140) and ground level both graphically and numerically, based on the strength of the magnetic fields reported by the other underground detecting devices; a photo relates to the underlying cable; a photo relates to the underlying cable (140) and its surroundings; the type of cable, according to frequency of signals reported by the other underground lying devices. If the present position has yet to be performed before, using the set of sensors to detect if any underlying cables (140) are found; when reportedly by the sensor (120) that a underlying cable (140) is found, detecting the distance; display numerically and graphically the cable (140) on the display unit, showing depth of the cable; sending an alert to the remote server to report its findings, wherein the alert includes information regarding the present position, the photo relating to the surrounding, the type of cable (140) by the frequency of signals detected by the underlying cable device, and the distance between the underlying cable (140) and the ground, and wherein the remote server allows another user to send requests to the remote server to query whether examinations of the present position have ever been performed before and whether any underlying cables (140) have been found; using the digging component for performing digging activities of the present position while using the set of sensors to closely monitor the shortening distance between the digging component and the underlying cable; warning about the shortening distance between the digging component and the underlying cable; sending the warning to the remote server about the digging activities and the shortening distance between the digging component and the underlying cable; and stopping the use of the digging component to further perform digging, when the distance between the digging component and the underlying cable reaches zero.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. An underground cable detecting device comprises:
a handle for detecting underground cables;
a panel attached on bottom of the handle;
a set of sensors attached to the panel, where the sensors are for detecting presence of cables by magnetic fields;
a display unit attached on top of the handle, wherein the display unit allows an operator of the detecting device to display:
a three-dimensional image showing a cable being laid underground, when the cable is being found underground;
the distance between the underlying cable and ground level both graphically and numerically, based on strength of the magnetic fields reported by the set of sensors attached to the panel;
a set of wheels attached on the bottom of the handle, allowing the operator to detect the underground cables with mobility;
a location locating unit attached to the panel, allowing the detecting device to identify its present position; and
a control unit attached to the panel, wherein the control unit comprises a processor and a memory storing a method that can be executed by the processor.

2. The device of claim 1, wherein the method comprises:
sending a request to a remote server to query whether an examination of the present position has ever been performed before and whether any underlying cables are found, wherein the present position is determined by the location locating unit, and the remote server centrally manages information of underlying cable information for all locations under its management;
if the present position has been performed before and an underlying cable was reportedly found by other underlying detecting devices, receiving a reply from the remote server, wherein the reply includes data from the remote server to be displayed on the display unit, the data containing
the distance between the underlying cable and ground level both graphically and numerically, based on the strength of the magnetic fields reported by the other underground detecting devices;
a photo relates to the underlying cable;
a photo relates to the underlying cable and its surroundings;
type of cable, according to frequency of signals reported by the other underground cable detecting devices; and
if the present position has yet to be performed before,
using the set of sensors to detect if any underlying cables are found;
when a cable is found,
detecting the distance;
displaying numerically and graphically the cable on the display unit; and
sending an alert to the remote server to report its findings, wherein the alert includes information regarding the present position, the photo relating to the surrounding, the type of cable by the frequency of signals detected by the underlying cable device, and the distance between the underlying cable and the ground, and wherein the remote server allows another user to send requests to the remote server to query whether examinations of the present position have ever been performed before and whether any underlying cables have been found.

3. The device of claim 1, wherein the method comprises:
sending a request to a remote server to query whether an examination of the present position has ever been performed before and whether any underlying cables are found, wherein the present position is determined by the location locating unit, and the remote server centrally manages information of underlying cable information for all locations under its management;
if the present position has been performed before and an underlying cable was reportedly found by other underlying detecting devices, receiving a reply from the remote server, wherein the reply includes data from the remote server to be displayed on the display unit, the data containing
the distance between the underlying cable and ground level both graphically and numerically, based on the strength of the magnetic fields reported by the other underground detecting devices;
a photo relates to the underlying cable;
a photo relates to the underlying cable and its surroundings;
the type of cable, according to frequency of signals reported by the other underground cable detecting devices; and
if the present position has yet to be performed before,
using the set of sensors to detect if any underlying cables are found;
when reportedly by the sensor that a underlying cable is found, detecting the distance;
displaying numerically and graphically the cable on the display unit, showing depth of the cable;
sending an alert to the remote server to report its findings, wherein the alert includes information regarding the present position, the photo relating to the surrounding, the type of cable by the frequency of signals detected by the underlying cable device, and the distance between the underlying cable and the ground, and wherein the remote server allows another user to send requests to the remote server to query whether examinations of the present position have ever been performed before and whether any underlying cables have been found;
using the digging component for performing digging of the present position while using the set of sensors to closely monitor the shortening distance between the digging component and the underlying cable;
warning about the shortening distance between the digging component and the underlying cable; and
stopping the use of the digging component to further perform digging, when the distance between the digging component and the underlying cable reaches an unacceptable level.

4. The device of claim 1, wherein the method comprises:
sending a request to a remote server to query whether an examination of the present position has ever been performed before and whether any underlying cables are found, wherein the present position is determined by the location locating unit, and the remote server centrally manages information of underlying cable information for all locations under its management;
if the present position has been performed before and an underlying cable was reportedly found by other underlying detecting devices, receiving a reply from the remote server, wherein the reply includes data from the remote server to be displayed on the display unit, the data containing
the distance between the underlying cable and ground level both graphically and numerically, based on the strength of the magnetic fields reported by the other underground detecting devices;
a photo relates to the underlying cable;
a photo relates to the underlying cable and its surroundings;
the type of cable, according to frequency of signals reported by the other underground lying devices; and
if the present position has yet to be performed before,
using the set of sensors to detect if any underlying cables are found;
when reportedly by the sensor that a underlying cable is found, detecting the distance;
displaying numerically and graphically the cable on the display unit, showing depth of the cable;
sending an alert to the remote server to report its findings, wherein the alert includes information regarding the present position, the photo relating to the surrounding, the type of cable by the frequency of signals detected by the underlying cable device, and the distance between the underlying cable and the ground, and wherein the remote server allows another user to send requests to the remote server to query whether examinations of the present position have ever been performed before and whether any underlying cables have been found;
using the digging component for performing digging activities of the present position while using the set of sensors to closely monitor the shortening distance between the digging component and the underlying cable;
warning about the shortening distance between the digging component and the underlying cable;
sending the warning to the remote server about the digging activities and the shortening distance between the digging component and the underlying cable; and
stopping the use of the digging component to further perform digging, when the distance between the digging component and the underlying cable reaches zero.
